(19) United States
(12) Patent Application Publication
(10) Pub. No.: US 2014/0049900 A1
(43) Pub. Date: Feb. 20, 2014

(54) ELECTRONIC DEVICE WITH CIRCUIT BOARD CONNECTING STRUCTURE

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: CHUN-SHENG CHEN, New Taipei (TW); JING WANG, Wuhan (CN)

(21) Appl. No.: 13/912,426

(22) Filed: Jun. 7, 2013

(30) Foreign Application Priority Data
Aug. 16, 2012 (CN) 2012102917285

(51) Int. Cl. G06F 1/18

(52) U.S. Cl. CPC G06F 1/18
USPC 361/679.31

(57) ABSTRACT

An electronic device includes a motherboard, at least one expansion circuit board, and a power unit. The power unit includes a number of output terminals for providing power signals with different voltages. The motherboard and the expansion circuit board are connected to a corresponding output terminal providing the power signal with a proper voltage via cables.

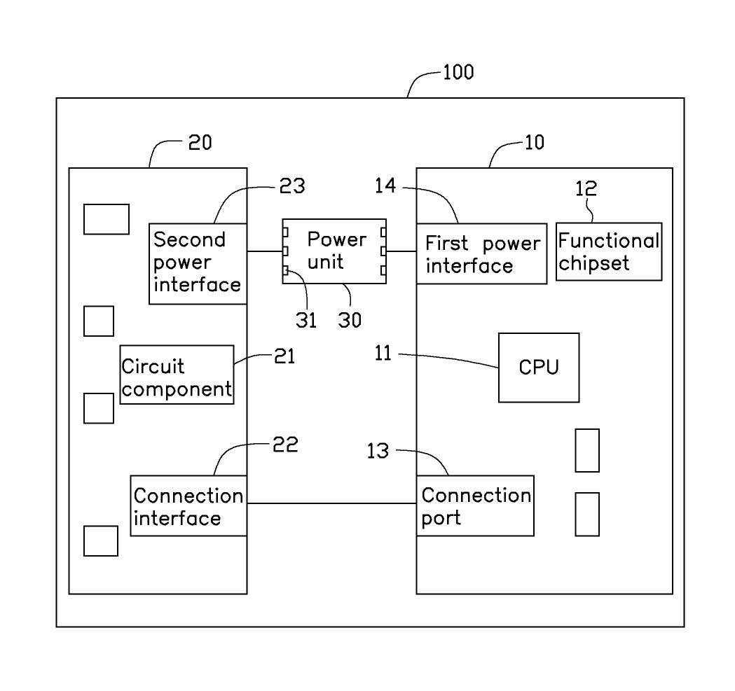

### BACKGROUND

1. Technical Field

The present disclosure relates to electronic devices, and more particularly to an electronic device with a circuit board connecting structure.

2. Description of Related Art

The motherboard of an electronic device needs different external expansion circuit boards to perform specific functions. However, the power supply unit of existing electronic device only supplies power to the motherboard directly, and then the motherboard supplies power to the expansion circuit boards via the power ports on the motherboard. Added to the motherboard are datum ports and wiring to transfer datum. Too many ports on the motherboard will interfere with each other, and also increase the manufacturing cost of the motherboard.

Therefore, an electronic device with a new circuit board connecting structure is needed.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

The FIGURE is a schematic block diagram of an electronic device with a circuit board connecting structure according to one embodiment of the present disclosure.

### DETAILED DESCRIPTION

Reference will now be made to the drawings to describe various embodiments in detail.

The FIGURE is a schematic block of an electronic device 100 with a circuit board connecting structure according to one embodiment of the present disclosure. The electronic device 100 includes a motherboard 10, at least one expansion circuit board 20, and a power unit 30. The power unit 30 includes a plurality of output terminals 31 for providing power signals with different voltages. The motherboard 10 and the expansion circuit board 20 are connected to a corresponding output terminal 31 providing the power signal with a proper voltage. The electronic device 100 can be, but not limited to, a server, a personal computer or a portable intelligent terminal In the illustrated embodiment, the electronic device 100 is a personal computer.

The motherboard 10 includes a CPU 11, a functional chipset 12, a connection port 13 and a first power interface 14. The expansion circuit board 20 is electrically connected to the motherboard 10 via the connection port 13. The connection port 13 is configured to exchange datum between the expansion circuit board 20 and motherboard 10. The expansion circuit board 20 includes circuit components 21, a connection interface 22 and a second power interface 23. The circuit components 21 are configured to realize specific functions, and the second power interface 23 is configured to receive power signal. The connection interface 22 is configured to connect with the corresponding connection port 13 on the motherboard 10. The expansion circuit board 20 can be, but not limited to, memory, graphics cards, network cards, sound cards, and universal serial bus hub (USB HUB). In the illustrated embodiment, the expansion circuit board 20 is a USB HUB. The functional chipset 12 includes a south bridge chipset and a north bridge chipset. The CPU 11 processes the datum and signals of the expansion circuit board 20 connected to the motherboard 10 with the aid of the functional chipset 12.

The power unit 30, which connects with an external power, is configured to transfer the external power signal to a number of power signals of different voltage which is to be provided to the components having different rated voltages in the electrical device 100, such as, the motherboard 10 or the expansion circuit board 20. Different power signals of the power unit 30 are output by the output terminals 31. In circuit connection, the first power interface 14 on the motherboard 10 and the second power interface 23 on the expansion circuit board 20 are connected to a corresponding output terminal providing the power signal with a proper voltage via a cable. In the illustrated embodiment, the expansion circuit board 20 is the USB HUB, and the second power interface 23 is connected to the output terminal 31 which provides voltage of 5 volts on the power unit 30.

The present disclosure provides electronic device 100 using the output terminal 31 of the power supply unit 30 to supply power to the expansion circuit board 20 connected to the motherboard 10 directly, so the need for setting ports to supply power to the expansion circuit board 20 on the motherboard 10 is eliminated. The present disclosure can reduce the number of ports set on the motherboard 10, and also reduce the manufacturing cost of the motherboard 10.

It is to be understood that even though numerous characteristics and advantages of the present embodiments have been set forth in the foregoing description, with details of the structures and functions of the embodiments, the disclosure is illustrative only; and that changes may be in detail, especially in matters of shape, size, and arrangement of parts, within the principles of the embodiments, to the full extent indicated by the broad general meaning of the terms in which the appended claims are expressed.

What is claimed is:

1. An electronic device comprising:
a motherboard;
at least one expansion circuit board electrically connected to the motherboard; and
a power unit comprising a plurality of output terminals for providing power signals with different voltages, wherein the motherboard and the expansion circuit board are connected to a corresponding output terminal of the power unit providing the power signal with a proper voltage via cables.

2. The electronic device of claim 1, wherein the motherboard comprises a connection port connected with the at least one expansion circuit board, and the connection port is configured to exchange datum between the at least one expansion circuit board and the motherboard.

3. The electronic device of claim 2, wherein the at least one expansion circuit board comprises a connection interface connected with the connection port.

4. The electronic device of claim 1, wherein the motherboard comprises a CPU and a functional chipset, and the CPU processes the signal and datum of the at least one expansion circuit board connected to the motherboard with aid of the functional chipset.

5. The electronic device of claim 4, wherein the functional chipset comprises a south chipset and a north chipset.

6. The electronic device of claim 1, wherein the at least one expansion circuit board is selected from a group consisting of memory, graphics card, network card, sound card, universal serial bus hub (USB HUB), and their combination.

7. The electronic device of claim 3, wherein a rated voltage of the at least one expansion circuit board is 5 volts, and the at least one expansion circuit board connects to the output terminal of the power unit which provides voltage of 5 volts via a cable.
